(19) United States
(12) Patent Application Publication
(10) Pub. No.: US 2026/0337434 A1
(43) Pub. Date: Oct. 29, 2026

(54) PLATINUM INK COMPOSITIONS AND METHODS FOR LOW TEMPERATURE CONDUCTIVE COATING

(71) Applicant: ELECTRONINKS INCORPORATED, Austin, TX (US)

(72) Inventors: S. Brett WALKER, Austin, TX (US); Ayan MAITY, Austin, TX (US); Maxwell Jacob TOLCHIN, State College, PA (US)

(73) Assignee: ELECTRONINKS INCORPORATED, Austin, TX (US)

(21) Appl. No.: 19/107,763

(22) PCT Filed: Aug. 30, 2023
(86) PCT No.: PCT/US2023/073121

§ 371 Date: Feb. 28, 2025

Related U.S. Application Data
(60) Provisional application No. 63/402,341, filed on Aug. 30, 2022.

(51) Int. Cl. C09D 11/52; C09D 11/38

(52) U.S. Cl. CPC C09D 11/52; C09D 11/38

(57) ABSTRACT

Conductive metal-organic decomposition (MOD) ink compositions comprising platinum are provided. Also provided are methods of preparing the conductive ink compositions, methods of forming conductive structures from the conductive ink compositions, and conductive structures formed from the conductive ink compositions, including dense conductive platinum films. The conductive ink compositions preferably comprise a platinum metal, a first bidentate complexing agent, and a solvent. Conductive platinum films can be formed from the ink compositions at low temperatures and are therefore suitable for use on a variety of substrates, including substrates of choice for electronic applications.

### CROSS-REFERENCE TO RELATED APPLICATIONS

This application claims the benefit of U.S. Provisional Application No. 63/402,341, filed on Aug. 30, 2022, the disclosure of which is incorporated herein by reference in its entirety.

### FIELD OF THE INVENTION

The present disclosure relates generally to novel ink compositions comprising platinum and their methods of preparation and use. More particularly, the present disclosure relates to metal-organic decomposition (MOD) platinum ink compositions that are suitable for use on low temperature substrates. The disclosure also describes methods of forming dense conductive platinum films by applying the disclosed platinum ink compositions onto substrates of choice for electronic applications and conductive platinum films formed by such methods.

### BACKGROUND OF THE INVENTION

The deposition of metallic platinum thin films on various substrates is gaining attention, particularly in the electronics industry. Such applications include the formation of contacts in microelectronic devices, as well as high temperature electrochemical and catalytic applications. Compared to more common noble metals such as gold and silver, the deposition of conductive platinum thin films is challenging, and related reports are sparse. Common deposition methods for platinum include gas-phase deposition, as well as electrochemical and electroless deposition methods. These conventional processes are often impractical, however, and are difficult to adapt for large scale production.

U.S. Pat. No. 5,882,722 discloses thick conductive films formed from a mixture of metal powders and metal-organic decomposition complexes in an organic liquid vehicle. The mixtures preferably include metal flake. Only silver-containing mixtures were exemplified, however.

Choi et al. (2019) Adv. Mater. Interfaces 6 1901002 provide a review of the status of metal-organic decomposition inks for printed electronics. Working examples of only silver, copper, and aluminum MOD inks were described, however.

Accordingly, there remains a need for conductive ink compositions comprising platinum that display improved properties. It is thus an object of the present invention to provide particle-free conductive platinum ink compositions and methods for their preparation and use, in particular compositions that can form conductive structures at low temperatures.

### SUMMARY OF THE INVENTION

The instant disclosure addresses these and other considerations by providing in some aspects a particle-free conductive ink composition including: a platinum metal; a first bidentate complexing agent; and a solvent; wherein the composition forms a conductive metallic film by curing at no more than 250 °C.

In some aspects, the techniques described herein relate to a particle-free conductive ink composition, wherein the platinum metal is a platinum (II) metal ion.

In some aspects, the techniques described herein relate to a particle-free conductive ink composition, wherein the first bidentate complexing agent is an amine-containing organic complexing agent.

In some aspects, the techniques described herein relate to a particle-free conductive ink composition, wherein the amine-containing organic complexing agent is a C₃-C₈ amino ether ligand.

In some aspects, the techniques described herein relate to a particle-free conductive ink composition, wherein the amine-containing organic complexing agent is a primary amino ether ligand.

In some aspects, the techniques described herein relate to a particle-free conductive ink composition, wherein the amine-containing organic complexing agent is a primary C₃-C₈ amino ether ligand.

In some aspects, the techniques described herein relate to a particle-free conductive ink composition, wherein the amine-containing organic complexing agent is 2-methoxy-ethylamine.

In some aspects, the techniques described herein relate to a particle-free conductive ink composition, wherein the solvent includes a terpene, a terpenoid, or a combination thereof.

In some aspects, the techniques described herein relate to a particle-free conductive ink composition, wherein the terpene is a purified terpene or the terpenoid is a purified terpenoid.

In some aspects, the techniques described herein relate to a particle-free conductive ink composition, wherein the terpene is a pinene or a limonene.

In some aspects, the techniques described herein relate to a particle-free conductive ink composition, wherein the terpenoid is a terpineol.

In some aspects, the techniques described herein relate to a particle-free conductive ink composition, wherein the solvent includes water.

In some aspects, the techniques described herein relate to a particle-free conductive ink composition, further including a second bidentate complexing agent.

In some aspects, the techniques described herein relate to a particle-free conductive ink composition, wherein the second bidentate complexing agent is a β-diketone.

In some aspects, the techniques described herein relate to a particle-free conductive ink composition, wherein the β-diketone is acetylacetonate.

In some aspects, the techniques described herein relate to a particle-free conductive ink composition, wherein the first bidentate complexing agent is 2-methoxy-ethylamine and the solvent includes a terpineol.

In some aspects, the techniques described herein relate to a particle-free conductive ink composition, further including a reducing ligand.

In some aspects, the techniques described herein relate to a particle-free conductive ink composition, wherein the reducing ligand is formic acid.

In some aspects, the techniques described herein relate to a particle-free conductive ink composition, further including a second bidentate complexing agent.

In some aspects, the techniques described herein relate to a particle-free conductive ink composition, wherein the second bidentate complexing agent is a β-diketone.

In some aspects, the techniques described herein relate to a particle-free conductive ink composition, wherein the β-diketone is acetylacetonate.

In some aspects, the techniques described herein relate to a particle-free conductive ink composition, wherein the first bidentate complexing agent is 2-methoxy-ethylamine and the solvent includes a terpineol.

In some aspects, the techniques described herein relate to a particle-free conductive ink composition, further including a glycol.

In some aspects, the techniques described herein relate to a particle-free conductive ink composition, wherein the glycol is 1,2-propylene glycol, 1,3-propylene glycol, or a combination thereof.

In some aspects, the techniques described herein relate to a particle-free conductive ink composition, wherein the first bidentate complexing agent is 2-methoxy-ethylamine and the solvent includes water.

In some aspects, the techniques described herein relate to a particle-free conductive ink composition, wherein the composition forms a conductive metallic film by curing at no more than 250 °C.

In some aspects, the techniques described herein relate to a particle-free conductive ink composition, wherein the composition forms a conductive metallic film by curing at no more than 200 °C/

In some aspects, the techniques described herein relate to a particle-free conductive ink composition, wherein the conductive metallic film displays a conductivity of at least 1% bulk metal conductivity.

In some aspects, the techniques described herein relate to a method of applying the above compositions to a substrate and curing the composition at an elevated temperature to form a conductive film.

In some aspects, the techniques described herein relate to a method, wherein the applying step includes printing.

In some aspects, the techniques described herein relate to a method, wherein the printing is jet printing.

In some aspects, the techniques described herein relate to a method, wherein the jet printing is aerosol jet printing.

In some aspects, the techniques described herein relate to a method, wherein the curing step is at no more than 250 °C.

In some aspects, the techniques described herein relate to a method, wherein the curing step is at no more than 200 °C.

In some aspects, the techniques described herein relate to a conductive film formed by applying the particle-free conductive ink composition to a substrate and curing the composition at no more than 250 °C to form the conductive film.

### BRIEF DESCRIPTION OF THE DRAWINGS

FIGS. 1A-1C show coating and imaging using a platinum ink composition of the disclosure.

### DETAILED DESCRIPTION OF THE INVENTION

### Conductive Platinum Ink Compositions

Provided herein are complex-based, particle free ink compositions comprising platinum. These ink compositions can be applied and cured at low temperatures in order to meet the needs of the current conductive printing industry.

The particle-free conductive ink compositions are stable formulations that can deposit pure platinum metal on a variety of substrates at temperatures as low as 150 °C, or even lower. The vast majority of commercially produced conductive inks are specifically designed for inkjet, screen-printing, or roll-to-roll processing methods in order to process large areas with fine-scale features in short time periods. These inks have disparate viscosities and synthesis parameters. Particle-based inks are based on conductive metal particles, which are typically synthesized separately and then incorporated into an ink formulation. The resulting ink is then tuned for specific particle process.

According to some aspects of the disclosure, the platinum ink formulations can comprise a platinum acetylacetonate as a precursor chelated by an amine ligand.

According to other aspects of the disclosure, the platinum ink formulations can comprise a platinum complex in combination with formic acid.

According to still other aspects of the disclosure are provided particle-free conductive ink compositions comprising a platinum metal, a first bidentate complexing agent, and a solvent. The particle-free conductive ink compositions preferably form a conductive metallic film by curing at no more than 250 °C. In preferred embodiments, the platinum metal is a platinum (II) metal ion.

As is understood by those of ordinary skill in the art, a bidentate complexing agent is a ligand that contains two donor groups capable of binding to a central metal atom in a coordination complex. In the instant compositions, the central metal atom is a platinum metal atom, and the first bidentate complexing agent comprises at least two heteroatoms. In specific embodiments, the at least two heteroatoms of the first bidentate complexing agent are at least two nitrogen atoms, at least two oxygen atoms, or at least a nitrogen atom and at least an oxygen atom.

In some embodiments, the first bidentate complexing agent of the instant particle-free conductive ink compositions is an amine-containing organic complexing agent. In some embodiments, the amine-containing organic complexing agent can be a C₃-C₈ alkylamine ligand. In other embodiments, the amine-containing organic complexing agent can be a primary amino ether ligand. In still other embodiments, the amine-containing organic complexing agent can be a primary C₃-C₈ amino ether ligand. In specific embodiments, the amine-containing organic complexing agent can be 2-methoxy-ethylamine.

The solvent used in the instant conductive ink compositions is ideally suitable for use at an industrial scale in mass production. In some embodiments, it can therefore be advantageous for the solvent to be non-toxic and/or to be less damaging to the environment than is the case for many commonly-used organic solvents. In some embodiments, it can be advantageous for the solvent to have a higher flash point than is the case for many commonly-used organic solvents. In some embodiments, it can be advantageous for the solvent to be subject to fewer regulations than is the case for many commonly-used organic solvents. For example, aromatic hydrocarbons such as xylene, toluene, mesitylene, and the like, are highly regulated in most industrial countries. The use alternatives to these solvents can therefore be advantageous. In addition, conductive inks formulated from aromatic hydrocarbons can have flash points that are lower than 60 °C and that are therefore not typically acceptable in mass production environments. Accordingly, in some embodiments, the solvent of the instant conductive ink compositions does not comprise an aromatic hydrocarbon, although in other embodiments, the solvent can comprise an aromatic solvent such as anisole, xylene, toluene or the like.

In some embodiments, the solvent comprises a polar, aprotic solvent. More specifically, the solvent can comprise a cyclic or acyclic ether solvent.

In more specific embodiments, the cyclic ether solvent can be a furan, such as tetrahyrofuran.

In other more specific embodiments, the acyclic ether solvent can be a glycol ether, a dialkyl ether, or an ester.

For example, the glycol ether can be ethylene glycol monomethyl ether (2-methoxyethanol, CH₃OCH₂CH₂OH), ethylene glycol monoethyl ether (2-ethoxyethanol, CH₃CH₂OCH₂CH₂OH), ethylene glycol monopropyl ether (2-propoxyethanol, CH₃CH₂CH₂OCH₂CH₂OH), ethylene glycol monoisopropyl ether (2-isopropoxyethanol, (CH₃)₂CHOCH₂CH₂OH), ethylene glycol monobutyl ether (2-butoxyethanol, CH₃CH₂CH₂CH₂OCH₂CH₂OH), ethylene glycol monophenyl ether (2-phenoxyethanol, C₆H₅OCH₂CH₂OH), ethylene glycol monobenzyl ether (2-benzyloxyethanol, C₆H₅CH₂OCH₂CH₂OH), propylene glycol methyl ether (1-methoxy-2-propanol, CH₃OCH₂CH(OH)CH₃), diethylene glycol monomethyl ether (2-(2-methoxyethoxy)ethanol, methyl carbitol, CH₃OCH₂CH₂OCH₂CH₂OH), diethylene glycol monoethyl ether (2-(2-ethoxyethoxy)ethanol, carbitol cellosolve, CH₃CH₂OCH₂CH₂OCH₂CH₂OH), diethylene glycol mono-n-butyl ether (2-(2-butoxyethoxy)ethanol, butyl carbitol, CH₃CH₂CH₂CH₂OCH₂CH₂OCH₂CH₂OH), dipropylene glycol methyl ether (CH₃O(CH₂CH(CH₃)O)₂H), or C12-15 pareth-12(CH₃(CH₂)ₙ-(CH₂CH₂O)m—H, where n=11−14 and m=12), which is also referred to as an ethoxylated C₁₂₋₁₅ alcohol.

For example, the dialkyl ether can be ethylene glycol dimethyl ether (dimethoxyethane, CH₃OCH₂CH₂OCH₃), ethylene glycol diethyl ether (diethoxyethane, CH₃CH₂OCH₂CH₂OCH₂CH₃), or ethylene glycol dibutyl ether (dibutoxyethane, CH₃CH₂CH₂CH₂OCH₂CH₂OCH₂CH₂CH₂CH₃).

For example, the ester can be ethylene glycol methyl ether acetate (2-methoxyethyl acetate, CH₃OCH₂CH₂OCOCH₃), ethylene glycol monoethyl ether acetate (2-ethoxyethyl acetate, CH₃CH₂OCH₂CH₂OCOCH₃), ethylene glycol monobutyl ether acetate (2-butoxyethyl acetate, CH₃CH₂CH₂CH₂OCH₂CH₂OCOCH₃), or propylene glycol methyl ether acetate (1-methoxy-2-propanol acetate).

Other glycols suitable for inclusion in the instant particle-free conductive ink compositions include 1,2-propylene glycol, 1,3-propylene glycol, or a combination thereof.

In some embodiments, the solvent comprises water.

In some embodiments, the solvent comprises a terpene, a terpenoid, or a combination thereof. For example, in some embodiments, the solvent comprises a pinene, a limonene, in particular a D-limonene, a terpineol, or a combination thereof. In preferred embodiments, the solvent comprises limonene. In other preferred embodiments, the solvent comprises terpineol. In still other preferred embodiments, the solvent comprises a combination of limonene and terpineol.

Not all terpenes and terpenoids may be suitable for use in the conductive ink compositions of the instant disclosure. For example, in some embodiments, the instant solvent does not comprise alpha-terpinene, gamma-terpinene, terpinolene, or terpene-4-ol. Alternatively, or in addition, in some embodiments, it can be advantageous for the solvent to be a purified form of the solvent. For example, in some embodiments, the solvent is a purified terpineol, a purified limonene, or a combination of a purified terpineol and a purified limonene. A purified solvent is understood to be at least 95% pure, at least 97% pure, at least 98% pure, at least 99% pure, or even more pure.

In some embodiments, the conductive ink compositions further comprise a second bidentate complexing agent. As was true for the first bidentate complexing agent, the second bidentate complexing agent comprises at least two heteroatoms. In specific embodiments, the at least two heteroatoms of the second bidentate complexing agent are at least two nitrogen atoms, at least two oxygen atoms, or at least a nitrogen atom and at least an oxygen atom.

In some embodiments, the second bidentate complexing agent comprises a ketone. In specific embodiments, the second bidentate complexing agent is a β-diketone. Even more specifically, the β-diketone is acetylacetonate.

In some embodiments, the conductive ink compositions further comprise a reducing ligand. More specifically, the reducing ligand can be an organic acid such as formic acid.

The conductive ink compositions may possess low viscosity so that they are compatible with a broad range of patterning techniques, including slot die coating, spin coating, roll-to-roll printing, including gravure, flexography, rotary screen printing, screen-printing, aerosol jet printing, inkjet printing, airbrushing, Mayer rod coating, flood coating, 3D printing, and electrohydrodynamic printing. In particular, the inks are compatible with inkjet printing, dip coating, and spray coating. The patterned features can be highly conductive at room temperature and can achieve bulk conductivity upon decomposing at mild temperatures (e.g., in some cases at less than about 100 °C). Finally, the ink compositions can remain stable at room temperature for months without particle precipitation.

Accordingly, conductive ink compositions (also referred to as “conductive inks” or “inks”) have been created for printing highly conductive features at low temperatures. Such inks can be stable, particle-free, and suitable for a wide range of patterning techniques. In some embodiments, a “particle-free” ink is one that does not include any particles at a diameter of greater than about 10 nm. In some embodiments, a “particle-free” ink is one that has less than about 1% particles, preferably less than about 0.1% particles. Platinum salts are employed in the inks as a precursor material, which ultimately yields the platinum in the platinum coatings, lines, or patterns of the structure formed in the printing process.

In some embodiments, the particle-free platinum ink composition is configured for application to a substrate. In some embodiments, the particle-free platinum ink composition can be converted to a conductive platinum structure at a temperature of about 250 °C or less. In some embodiments, the particle-free platinum ink composition can be converted to a conductive platinum structure at a temperature of about 100 °C or less. In some embodiments, the particle-free platinum ink composition can be converted to a conductive platinum structure at a temperature of about 220 °C or less, of about 210 °C or less, of about 190 °C or less, of about 180 °C or less, of about 170 °C or less, of about 160 °C or less, of about 150 °C or less, of about 140 °C or less, of about 130 °C or less, of about 120 °C or less, of about 110 °C or less, of about 90 °C or less, of about 80 °C or less, of about 70 °C or less, of about 60 °C or less, or even of about 50 °C or less.

In some embodiments, the particle-free platinum conductive ink composition has a concentration of about 1 to about 50 weight percent platinum of the conductive ink composition. In some embodiments, the particle-free platinum conductive ink composition has a concentration of about 1 to about 40 weight percent platinum of the conductive ink composition. In some embodiments, the particle-free platinum conductive ink composition has a concentration of about 1 to about 30 weight percent platinum of the conductive ink composition. In some embodiments, the particle-free platinum conductive ink composition has a concentration of about 1 to about 20 weight percent platinum of the conductive ink composition. In some embodiments, the particle-free platinum conductive ink composition has a concentration of about 1 to about 10 weight percent platinum of the conductive ink composition. In some embodiments, the particle-free platinum conductive ink composition has a concentration of about 5 to about 15 weight percent platinum of the conductive ink composition. In some embodiments, the particle-free platinum conductive ink composition has a concentration of about 1 weight percent, about 2 weight percent, about 3 weight percent, about 4 weight percent, about 5 weight percent, about 6 weight percent, about 7 weight percent, about 8 weight percent, about 9 weight percent, about 10 weight percent, about 11 weight percent, about 12 weight percent, about 13 weight percent, about 14 weight percent, about 15 weight percent, about 16 weight percent, about 17 weight percent, about 18 weight percent, about 19 weight percent, about 20 weight percent, about 21 weight percent, about 22 weight percent, about 23 weight percent, about 24 weight percent, about 25 weight percent, about 26 weight percent, about 27 weight percent, about 28 weight percent, about 29 weight percent, about 30 weight percent, about 31 weight percent, about 32 weight percent, about 33 weight percent, about 34 weight percent, about 35 weight percent, about 36 weight percent, about 37 weight percent, about 38 weight percent, about 39 weight percent, about 40 weight percent, about 41 weight percent, about 42 weight percent, about 43 weight percent, about 44 weight percent, about 45 weight percent, about 46 weight percent, about 47 weight percent, about 48 weight percent, about 49 weight percent, about 50 weight percent, or even higher weight percent platinum in the conductive ink composition.

In some embodiments, the particle-free platinum conductive ink compositions of the instant disclosure have a desired viscosity. In some embodiments, the desired viscosity is obtained using a micro VISC viscometer. In some embodiments, the viscosity is measured at room temperature, such as at, or about, 22 °C. In some embodiments, the conductive ink composition has a viscosity from about 50 centipoise to about 1000 centipoise. In some embodiments, the conductive ink composition has a viscosity from about 0.5 centipoise to about 50 centipoise. In some embodiments, the conductive ink composition has a viscosity from about 1.0 centipoise to about 40 centipoise. In some embodiments, the conductive ink composition has a viscosity from about 2 centipoise to about 30 centipoise. In some embodiments, the conductive ink composition has a viscosity from about 0.5 centipoise to about 10 centipoise. In some embodiments, the conductive ink composition has a viscosity of about 1.0, about 2.0, or about 3.0 centipoise. In some embodiments, the conductive ink composition has a viscosity of at least about 0.5 centipoise, about 1.0 centipoise, about 2.0 centipoise, about 3.0 centipoise, about 4.0 centipoise, about 5.0 centipoise, about 6.0 centipoise, about 7.0 centipoise, about 8.0 centipoise, about 9.0 centipoise, about 10.0 centipoise, about 20.0 centipoise, about 30.0 centipoise, about 40.0 centipoise, about 50.0 centipoise, about 60.0 centipoise, about 70.0 centipoise, about 80.0 centipoise, or about 90.0 centipoise. In some embodiments, the conductive ink composition has a viscosity of at most about 100.0 centipoise, about 90.0 centipoise, about 80.0 centipoise, about 70.0 centipoise, about 60.0 centipoise, about 50.0 centipoise, about 40.0 centipoise, about 30.0 centipoise, about 20.0 centipoise, about 10.0 centipoise, about 9.0 centipoise, about 8.0 centipoise, about 7.0 centipoise, about 6.0 centipoise, about 5.0 centipoise, about 4.0 centipoise, about 3.0 centipoise, about 2.0 centipoise, or about 1.0 centipoise.

In some embodiments, the conductive ink composition has a viscosity of 0.8-1.3 centipoise at 22 °C

### Methods for Forming a Conductive Structure

In another aspect are disclosed methods of making conductive structures, such as conductive platinum films. In some embodiments, the methods include the step of applying any of the above-described conductive ink compositions to a substrate. In some embodiments, the methods include the step of heating the conductive ink composition on the substrate at a decomposition temperature of about 250 °C or less to form the conductive structure. In some embodiments, the methods include the step of heating the conductive ink composition on the substrate at a decomposition temperature of about 220 °C or less, of about 200 °C or less, of about 190 °C, of about 180 °C or less, of about 170 °C or less, of about 160 °C, of about 150 °C or less, of about 140 °C or less, of about 130 °C or less, of about 120 °C or less, of about 110 °C or less, of about 90 °C or less, of about 80 °C or less, of about 70 °C or less, of about 60 °C or less, or of about 50 °C or less to form the conductive structure. In some embodiments, the conductive ink composition is heated with a heat source. Examples of heat sources include an IR lamp, oven, or a heated substrate.

In some embodiments, the electrical conductivity of the conductive structure formed from the conductive ink composition is measured. In some embodiments, the electrical conductivity of the conductive structure is from about 2×10⁻⁶ Ohm-cm to about 1×10⁻⁵ Ohm-cm. In some embodiments, the electrical conductivity of the conductive structure is from about 3×10−6 Ohm-cm to about 6×10⁻⁶ Ohm-cm. In some embodiments, the electrical conductivity of the conductive structure is at least about 2×10⁻⁶ Ohm-cm, about 3×10⁻⁶ Ohm-cm, about 4×10⁻⁶ Ohm-cm, about 5×10 ⁻⁶ Ohm-cm, about 6×10⁻⁶ Ohm-cm, about 7×10⁻⁶ Ohm-cm, about 8×10⁻⁶ Ohm-cm, or about 9×10⁻⁶ Ohm-cm. In some embodiments, the electrical conductivity of the conductive structure is at most about 1×10⁻⁵ Ohm-cm, about 9×10⁻⁶ Ohm-cm, about 8−10⁻⁶ Ohm-cm, about 7×10⁻⁶ Ohm-cm, about 6×10⁻⁶ Ohm-cm, about 5×10⁻⁶ Ohm-cm, about 4×10⁻⁶ Ohm-cm, or about 3×10⁻⁶ Ohm-cm.

The electrical conductivity of the conductive structure can in some embodiments be expressed in terms of sheet resistance (i.e., bulk resistivity divided by thickness) in units of ohms per square (also referred to as ohms/square or OPS). For example, in some embodiments, the resistance of the conductive structure is no more than 5 ohms per square, no more than 2 ohms per square, no more than 1 ohm per square, no more than 0.5 ohms per square, or even lower. Preferably, the resistance of the conductive structure is no more than 1 ohm per square.

The conductive ink compositions of the instant disclosure can be used to form conductive structures having high levels of bulk platinum. Specifically, in some embodiments, the conductive structure has a bulk platinum content of at least 1%. In more specific embodiments, the conductive structure has a bulk platinum content of at least 2%, at least 5%, at least 10%, at least 15%, at least 20%, or even higher.

### Applications of the Conductive Ink Compositions

The conductive ink compositions of the instant disclosure can be used in various printing applications, including slot die coating, spin coating, roll-to-roll printing, including gravure, flexography, rotary screen printing, screen printing, aerosol jet printing, inkjet printing, airbrushing, Mayer rod coating, flood coating, 3D printing, dispenser, and electrohydrodynamic printing. In particular, the inks can be used in inkjet printing, dip coating, and spray coating.

Furthermore, patterns can be created using photolithography to create a mask to etch silver from certain areas, thereby creating high-fidelity features. Both positive and negative patterning processes may be used to create the patterns.

In some embodiments, the particle-free platinum conductive ink composition is applied to a polymer substrate. In some embodiments, the particle-free platinum conductive ink composition is applied to a nonpolar polymer substrate. In some embodiments, the particle-free platinum conductive ink composition is applied to a glass substrate. In some embodiments, the particle-free platinum conductive ink composition is applied to a ceramic substrate.

Furthermore, elastomers and 3D substrates with specifically non-planar topography can be used in conjunction with the conductive structures. In some embodiments, the particle-free platinum conductive ink composition is applied to an elastomer. In some embodiments, the particle-free platinum conductive ink composition is applied to a 3D substrate.

In some embodiments, the particle-free platinum conductive ink composition of the instant methods has a concentration of about 0.1-50 weight percent platinum of the ink composition. In some embodiments, the ink composition of the instant methods has a concentration of about 0.1-40 weight percent platinum of the ink composition. In some embodiments, the ink composition has a concentration of about 1-30 weight percent platinum of the ink composition. In some embodiments, the ink composition has a concentration of about 1-20 weight percent platinum of the ink composition. In some embodiments, the ink composition has a concentration of about 1-10 weight percent platinum of the ink composition. In some embodiments, the ink composition has a concentration of about 5 -15 weight percent platinum of the ink composition. In some embodiments, the ink composition has a concentration of about 0.1 weight percent, about 0.2 weight percent, about 0.3 weight percent, about 0.4 weight percent, about 0.5 weight percent, about 0.6 weight percent, about 0.7 weight percent, about 0.8 weight percent, about 0.9 weight percent, about 1 weight percent, about 2 weight percent, about 3 weight percent, about 4 weight percent, about 5 weight percent, about 6 weight percent, about 7 weight percent, about 8 weight percent, about 9 weight percent, about 10 weight percent, about 11 weight percent, about 12 weight percent, about 13 weight percent, about 14 weight percent, about 15 weight percent, about 16 weight percent, about 17 weight percent, about 18 weight percent, about 19 weight percent, or about 20 weight percent platinum of the ink composition.

In some embodiments, the ink composition of the instant methods has a concentration of at least about 0.1 weight percent, about 0.2 weight percent, about 0.3 weight percent, about 0.4 weight percent, about 0.5 weight percent, about 0.6 weight percent, about 0.7 weight percent, about 0.8 weight percent, about 0.9 weight percent, 1 weight percent, about 2 weight percent, about 3 weight percent, about 4 weight percent, about 5 weight percent, about 6 weight percent, about 7 weight percent, about 8 weight percent, about 9 weight percent, about 10 weight percent, about 11 weight percent, about 12 weight percent, about 13 weight percent, about 14 weight percent, about 15 weight percent, about 16 weight percent, about 17 weight percent, about 18 weight percent, about 19 weight percent, or about 20 weight percent metal salt of the ink composition. In some embodiments, the ink composition has a concentration of at most about 40 weight percent, about 39 weight percent, about 38 weight percent, about 37 weight percent, about 36 weight percent, about 35 weight percent, about 34 weight percent, about 33 weight percent, about 32 weight percent, 31 weight percent, about 30 weight percent, about 29 weight percent, about 28 weight percent, about 27 weight percent, about 26 weight percent, about 25 weight percent, about 24 weight percent, about 23 weight percent, about 22 weight percent, about 21 weight percent, about 20 weight percent, about 19 weight percent, about 18 weight percent, about 17 weight percent, about 16 weight percent, about 15 weight percent, about 14 weight percent, about 13 weight percent, or about 12 weight percent platinum of the ink composition.

In some embodiments, the ink composition of the instant methods has a concentration of about 0.1-50 weight percent platinum of the ink composition. In some embodiments, the ink composition of the instant methods has a concentration of about 0.1-40 weight percent platinum of the ink composition. In some embodiments, the ink composition has a concentration of about 1-30 weight percent platinum of the ink composition. In some embodiments, the ink composition has a concentration of about 1-20 weight percent platinum of the ink composition. In some embodiments, the ink composition has a concentration of about 1-10 weight percent platinum of the ink composition. In some embodiments, the ink composition has a concentration of about 5 -15 weight percent platinum of the ink composition. In some embodiments, the ink composition has a concentration of about 0.1 weight percent, about 0.2 weight percent, about 0.3 weight percent, about 0.4 weight percent, about 0.5 weight percent, about 0.6 weight percent, about 0.7 weight percent, about 0.8 weight percent, about 0.9 weight percent, 1 weight percent, about 2 weight percent, about 3 weight percent, about 4 weight percent, about 5 weight percent, about 6 weight percent, about 7 weight percent, about 8 weight percent, about 9 weight percent, about 10 weight percent, about 11 weight percent, about 12 weight percent, about 13 weight percent, about 14 weight percent, about 15 weight percent, about 16 weight percent, about 17 weight percent, about 18 weight percent, about 19 weight percent, or about 20 weight percent platinum of the ink composition.

### Decomposition

In another aspect, the particle-free platinum conductive ink compositions of the disclosure are decomposed on a substrate to form a conductive structure on the substrate. In some embodiments, the particle-free platinum conductive ink composition is decomposed by heating the composition at a temperature of about 270 °C or less. In some embodiments, the conductive ink composition is decomposed by heating the composition at a temperature of about 260 °C or less, about 250 °C or less, about 240 °C or less, about 230 °C or less, about 220 °C or less, about 210 °C or less, about 200 °C or less, about 190 °C or less, about 180 °C or less, about 170 °C or less, about 160 °C or less, about 150 °C or less, about 140 °C or less, about 130 °C or less, about 120 °C or less, about 110 °C or less, about 100 °C or less, about 90 °C or less, about 80 °C or less, or about 70 °C or less. In some embodiments, the conductive ink composition is heated by a heat source. Examples of heat sources include an IR lamp, oven, or a heated substrate.

In some embodiments, the conductive ink composition is decomposed by exposing the composition to a light source at a wavelength from about 100 nm to about 1500 nm. In some embodiments, the conductive ink composition is decomposed by exposing the composition to a light source such as a Xenon lamp or IR lamp at a wavelength from about 100 nm to about 1000 nm. In some embodiments, the conductive ink composition is decomposed by exposing the composition to a light source at a wavelength from about 100 nm to about 700 nm. In some embodiments, the conductive ink composition is decomposed by exposing the composition to a light source at a wavelength from about 100 nm to about 500 nm. In some embodiments, the conductive ink composition is decomposed by exposing the composition to a light source at a wavelength from about 100 nm to about 300 nm. In some embodiments, the conductive ink composition is decomposed by exposing the composition to a light source at a wavelength of about 100 nm, about 200 nm, about 300 nm, about 400 nm, about 500 nm, about 600 nm, about 700 nm, about 800 nm, about 900 nm, or about 1000 nm.

In some embodiments, the conductive ink composition is decomposed by a combination of heating the reducible metal complex, for example at any of the above-listed temperatures, and exposing the composition to a light source, for example at any of the above-listed wavelengths.

In some embodiments, the electrical conductivity of the conductive structures is measured. In some embodiments, the electrical conductivity of the conductive structures is about 1×10⁻⁶ Ohm-cm or greater. In some embodiments, the electrical conductivity of the conductive structures is from about 1×10⁻⁶ Ohm-cm to about 8×10⁻⁴ Ohm-cm. In some embodiments, the electrical conductivity of the conductive structures is from about 3×10⁻⁶ Ohm-cm to about 6×10⁻⁶ Ohm-cm. In some embodiments, the electrical conductivity of the conductive structures is at least about 1×10⁻⁶ Ohm-cm, about 2×10⁻⁶ Ohm-cm, about 3×10⁻⁶ Ohm-cm, about 4×10⁻⁶ Ohm-cm, about 5×10⁻⁶ Ohm-cm, about 6×10⁻⁶ Ohm-cm, about 7×10⁻⁶ Ohm-cm, about 8×10⁻⁶ Ohm-cm, about 9×10⁻⁶ Ohm-cm, about 1×10⁻⁵ Ohm-cm, about 2×10⁻⁵ Ohm-cm, about 3×10⁻⁵ Ohm-cm, about 4×10⁻⁵ Ohm-cm, about 5×10⁻⁵ Ohm-cm, about 6×10⁻⁵ Ohm-cm, about 7×10⁻⁵ Ohm-cm, about 8×10⁻⁵ Ohm-cm, about 9×10⁻⁵ Ohm-cm, about 1×10⁻⁴ Ohm-cm, about 2×10⁻⁴ Ohm-cm, about 3−10⁻⁴ Ohm-cm, about 4×10⁻⁴ Ohm-cm, about 5×10⁻⁴ Ohm-cm, about 6×10⁻⁴ Ohm-cm, or about 7×10⁻⁴ Ohm-cm. In some embodiments, the electrical conductivity of the conductive structures is at most about 8×10⁻⁴ Ohm-cm, 7×10⁻⁴ Ohm-cm, about 6×10⁻⁴ Ohm-cm, about 5×10⁻⁴ Ohm-cm, about 4×10⁻⁴ Ohm-cm, about 3×10⁻⁴ Ohm-cm, about 2×10⁻⁴ Ohm-cm, or about 1×10⁻⁴ Ohm-cm, about 9×10⁻⁵ Ohm-cm, about 8×10⁻⁵ Ohm-cm, about 7×10⁻⁵ Ohm-cm, about 6×10⁻⁵ Ohm-cm, about 5×10⁻⁵ Ohm-cm, about 4×10⁻⁵ Ohm-cm, about 3×10⁻⁵ Ohm-cm, about 2×10⁻⁵ Ohm-cm, about 1×10⁻⁵ Ohm-cm, about 9×10⁻⁶ Ohm-cm, about 8×10⁻⁶ Ohm-cm, about 7×10⁻⁶ Ohm-cm, about 6×10⁻⁶ Ohm-cm, about 5×10⁻⁶ Ohm-cm, about 4×10⁻⁶ Ohm-cm, about 3×10⁻⁶ Ohm-cm, or about 2×10⁻⁶ Ohm-cm.

### Applications of the Ink Compositions

The ink compositions of the instant disclosure can be used in various printing applications, including slot die coating, spin coating, roll-to-roll printing, including gravure, flexography, rotary screen printing, screen printing, aerosol jet printing, inkjet printing, airbrushing, Mayer rod coating, flood coating, 3D printing, and electrohydrodynamic painting. In particular, the inks can be used in inkjet printing, dip coating, and spray coating. Furthermore, patterns can be created using photolithography to create a mask to etch the platinum from certain areas, thereby creating high-fidelity features.

In preferred embodiments, the ink compositions are used in aerosol jet printing applications to print conductive structures comprising platinum metal. This method, which is also known as maskless mesoscale materials deposition or M3D (see, e.g., U.S. Pat. No. 7,485,345), involves atomization of the particle-free ink composition, via ultrasonic or pneumatic techniques, to generate droplets of micrometer scale. The aerosolized ink is combined with a carrier gas and directed via a flowhead onto a substrate where the ink is ultimately cured to a conductive structure.

In some embodiments, the ink compositions are compatible with many nonpolar polymer substrates, glasses, and ceramic substrates, where polar complexes do not wet particularly well. In some embodiments, the ink composition is applied to a polymer substrate. In some embodiments, the ink composition is applied to a nonpolar polymer substrate. In some embodiments, the ink composition is applied to a glass substrate. In some embodiments, the ink composition is applied to a ceramic substrate.

Furthermore, elastomers and 3D substrates with specifically non-planar topography can be used in conjunction with the conductive structures. In some embodiments, the ink composition is applied to an elastomer. In some embodiments, the ink composition is applied to a 3D substrate.

It will be readily apparent to one of ordinary skill in the relevant arts that other suitable modifications and adaptations to the compositions and methods described herein may be made without departing from the scope of the invention or any embodiment thereof. Having now described the present invention in detail, the same will be more clearly understood by reference to the following Examples, which are included herewith for purposes of illustration only and are not intended to be limiting of the invention.

### EXAMPLES

### Porous Platinum Ink Formulation and Corresponding Film Characterization

1.500 grams (5.000 mmol) tetraammineplatinum (II) hydroxide hydrate (Pt(NH₂)₄(OH)₂·H₂O) was dissolved in 4.500 grams (250.000 mmol) water under ambient conditions and mechanically vortexed until complete solubility of the mixture was reached. Once a one phase solution was achieved, 0.768 grams (10.093 mmol) 1,2-propylene glycol (C₃H₈O₂) was pipetted into the mixture via drop-wise addition and vortexed thereafter to ensure sufficient stirring. Following a second vortex step, an equimolar amount 0.768 grams (10.093 mmol) 1,3-propylene glycol (C₃H₈O₂) was added to the resulting mixture and mechanically vortexed for the third time. The final component of 0.359 grams (4.780 mmol) 2-methoxyethylamine (CH₃OCH₂CH₂NH₂) was added to the overall solution and vortexed. A transparent, colorless solution was obtained and filtered using an 8 mL Luer lock syringe with a 0.22 μm PTFE filter attachment into a glass vial deemed suitable for ink printing characterization.

Upon a 100 μL drop-cast deposition onto glass or wafer substrate, the film was thermally treated to 80 °C on a hot plate for 10 minutes to which the film turns to an off-white color. The film was annealed in a binder oven at 200 °C for 30 minutes, exhibiting a white to red to metallic gray transitional sequence, denoting that the platinum complex has decomposed into a metallic, conductive structure. Using a multimeter for resistance measurements, the platinum film had an electrical resistance of 178 to 400 Ohms after 30 minutes at 1.1 to 1.9 cm in diameter respectively. The electrical resistance may vary depending on the printing method and thermal decomposition appliance used to characterize the porous platinum ink.

### Dense Platinum Ink Formulation and Corresponding Film Characterization

5.027 grams 2-methoxyethylamine (CH₃OCH₂CH₂NH₂) was pipetted into a glass vial followed by 1.267 grams (8.213 mmol) terpineol (C₁₀H₁₈O) under ambient conditions and mechanically vortexed to ensure sufficient stirring. The resulting mixture was then treated with 0.706 grams (1.800 mmol) platinum (II) acetylacetonate (PtC₅H₇O₂)₂ to give a yellow, two phase solution. A two-part stirring method required to dissolve the precursor included a 12 to 16 hour ambient stir followed by a 65 °C stir for 2 hours. After summation, the ink was a clear, red solution with complete solvation of the platinum precursor and was filtered using an 8 mL Luer lock syringe with a 0.22 μm PTFE filter attachment and ready for immediate ink printing demands.

Upon blade coating with a desired 15 μm wet thickness, the ink was annealed in a binder oven for 1 hour at 230 °C and on a hot plate at 200 °C, exhibiting a red to black to metallic gray-black transitional sequence, denoting that the platinum complex has decomposed fully into a native, conductive platinum network. Using a four-point probe apparatus, the platinum film had an electrical sheet resistance of 19 Ohms/square (OPS) after 1 hour at 230 °C in a binder oven and 48 OPS after 1 hour on a hot plate at 200 °C.

The electrical resistance may vary depending on the printing method and thermal decomposition appliance used to characterize the dense platinum ink.

### Typical Ink Formulations With Platinum (ii) Acetylacetonate, Curing Profile and Electrical Properties:

### Ink Formula 1

1.627 g (46 wt. %) 2-methoxyethylamine and 0.175 g (5 wt. %) terpineol were mixed under ambient conditions. The resulting mixture was then treated with 0.706 grams (20 wt. %) platinum (II) acetylacetonate to give a yellow suspension. The resulting mixture was then stirred under ambient conditions for 12-16 h followed by stirring at 65 °C for 2 hours. After this period complete dissolution of the precursor was observed. The resulting solution was passed through a 0.22 um PTFE filter to obtain a clear stable red solution. To this was added 0.998 g (28 wt. %) 1-hexanol. The viscosity of the ink was determined to be 3.7 centipoise and 10 wt. % solid content.

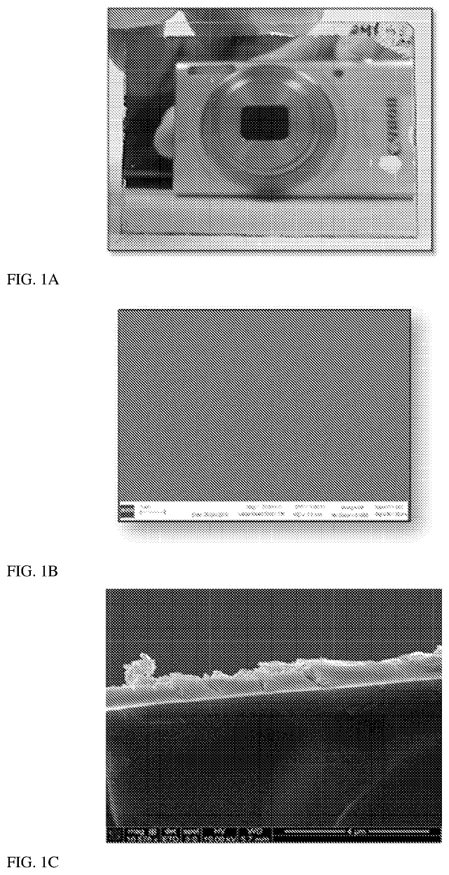

The prepared ink can be blade/bar coated onto various substrates such as glass, polyimide etc. Alternatively, the ink can also be aerosol jetted onto the substate of choice depending on the application. Typical annealing method includes heating for 1 h at 230 °C in convection oven or on a hot plate at 200 °C for 1 h. The ink exhibits a red to black to metallic gray-black transition leaving a smooth reflective surface during the annealing sequence, denoting that the platinum complex has converted into its metallic form. FIG. 1A shows the reflection of a camera photographing a 3×2 inch glass slide coated with platinum ink using a 20 um blade, cured at 200 °C for 1 h. Using a four-point probe apparatus, the platinum film had an electrical sheet resistance of 19 Ohms/square (Ω/) after 1 hour at 230 °C in a binder oven and 48 Ω/after 1 hour on a hot plate at 200 °C

The electrical resistance may vary depending on the printing method and thermal decomposition appliance used to characterize the dense platinum ink. Scanning microscope imaging of the surface (FIG. 1B, at 25K magnified optical image) and edge (FIG. 1C, at 10.5K magnification SEM imaging) reveal a tightly packed structure forming a dense film.

### Low Temperature Platinum Ink Formulations With Platinum (ii) Acetylacetonate and Formic Acid:

### Ink Formula 2

1.696 g (33.9 wt. %) 2-methoxyethylamine and 0.250 g (5 wt. %) terpineol were mixed under ambient conditions. The resulting mixture was then treated with 0.740 grams (14.8 wt. %) platinum (II) acetylacetonate to give a yellow suspension. The resulting mixture was then stirred under ambient conditions for 12-16 h followed by stirring at 65 °C for 2 hours. After this period complete dissolution of the precursor was observed. The resulting solution was passed through a 0.22 um PTFE filter to obtain a clear stable red solution. To this was added 2.227 g (44.5 wt. %) 1-hexanol followed by 0.087 g (1.7 wt. %, 1:1 ratio with Pt) of formic acid to form clear solution. The viscosity of the ink was determined to be - - - centipoise and - - - % solid content.

The prepared ink can be blade/bar coated onto various substrates such as glass, polyimide etc. Alternatively, the ink can also be aerosol jetted onto the substate of choice depending on the application. The low curing ink was blade coated on glass slides and annealed inside convection oven for at 150 °C for 1 h to form a dense film of metallic platinum. The electrical resistance may vary depending on the printing method and thermal decomposition appliance used to characterize the dense platinum ink.

All patents, patent publications, and other published references mentioned herein are hereby incorporated by reference in their entireties as if each had been individually and specifically incorporated by reference herein.

While specific examples have been provided, the above description is illustrative and not restrictive. Any one or more of the features of the previously described embodiments can be combined in any manner with one or more features of any other embodiments in the present invention. Furthermore, many variations of the invention will become apparent to those skilled in the art upon review of the specification. The scope of the invention should, therefore, be determined by reference to the appended claims, along with their full scope of equivalents.

What is claimed is:

1. A particle-free conductive ink composition comprising:
a platinum metal;
a first bidentate complexing agent; and
a solvent;
wherein the composition forms a conductive metallic film by curing at no more than 250 °C.

2. The particle-free conductive ink composition of claim 1, wherein the platinum metal is a platinum (II) metal ion.

3. The particle-free conductive ink composition of claim 1, wherein the first bidentate complexing agent is an amine-containing organic complexing agent.

4. The particle-free conductive ink composition of claim 3, wherein the amine-containing organic complexing agent is a C₃-C₈ amino ether ligand.

5. The particle-free conductive ink composition of claim 3, wherein the amine-containing organic complexing agent is a primary amino ether ligand.

6. The particle-free conductive ink composition of claim 3, wherein the amine-containing organic complexing agent is a primary C₃-C₈ amino ether ligand.

7. The particle-free conductive ink composition of claim 3, wherein the amine-containing organic complexing agent is 2-methoxy-ethylamine.

8. The particle-free conductive ink composition of claim 1, wherein the solvent comprises a terpene, a terpenoid, or a combination thereof.

9. The particle-free conductive ink composition of claim 8, wherein the terpene is a purified terpene or the terpenoid is a purified terpenoid.

10. The particle-free conductive ink composition of claim 8, wherein the terpene is a pinene or a limonene.

11. The particle-free conductive ink composition of claim 8, wherein the terpenoid is a terpineol.

12. The particle-free conductive ink composition of claim 1, wherein the solvent comprises water.

13. The particle-free conductive ink composition of claim 1, further comprising a second bidentate complexing agent.

14. The particle-free conductive ink composition of claim 13, wherein the second bidentate complexing agent is a β-diketone.

15. The particle-free conductive ink composition of claim 14, wherein the β-diketone is acetylacetonate.

16. The particle-free conductive ink composition of claim 15, wherein the first bidentate complexing agent is 2-methoxy-ethylamine and the solvent comprises a terpineol.

17. The particle-free conductive ink composition of claim 1, further comprising a reducing ligand.

18. The particle-free conductive ink composition of claim 17, wherein the reducing ligand is formic acid.

19. The particle-free conductive ink composition of claim 17, further comprising a second bidentate complexing agent.

20. The particle-free conductive ink composition of claim 19, wherein the second bidentate complexing agent is a β-diketone.

21. The particle-free conductive ink composition of claim 20, wherein the β-diketone is acetylacetonate.

22. The particle-free conductive ink composition of claim 21, wherein the first bidentate complexing agent is 2-methoxy-ethylamine and the solvent comprises a terpineol.

23. The particle-free conductive ink composition of claim 1, further comprising a glycol.

24. The particle-free conductive ink composition of claim 23, wherein the glycol is 1,2-propylene glycol, 1,3-propylene glycol, or a combination thereof.

25. The particle-free conductive ink composition of claim 24, wherein the first bidentate complexing agent is 2-methoxy-ethylamine and the solvent comprises water.

26. The particle-free conductive ink composition of any one of claims 1-25, wherein the composition forms a conductive metallic film by curing at no more than 250 °C.

27. The particle-free conductive ink composition of claim 26, wherein the composition forms a conductive metallic film by curing at no more than 200 °C.

28. The particle-free conductive ink composition of any one of claims 1-25, wherein the conductive metallic film displays a conductivity of at least 1% bulk metal conductivity.

29. A method of forming a conductive film comprising the steps of:
providing the particle-free conductive ink composition of any one of claims 1-25;
applying the composition to a substrate; and
curing the composition at an elevated temperature to form the conductive film.

30. The method of claim 29, wherein the applying step comprises printing.

31. The method of claim 30, wherein the printing is jet printing.

32. The method of claim 31, wherein the jet printing is aerosol jet printing.

33. The method of claim 29, wherein the curing step is at no more than 250 °C.

34. The method of claim 33, wherein the curing step is at no more than 200 °C.

35. A conductive film formed by applying the particle-free conductive ink composition of any one of claims 1-25 to a substrate and curing the composition at no more than 250 °C to form the conductive film.
